(19) United States
(12) Patent Application Publication
(10) Pub. No.: US 2002/0091342 A1
(43) Pub. Date: Jul. 11, 2002

(54) Protector for cervical vertebra

(76) Inventor: Spencer Tsai, Taichung (TW)

Correspondence Address: Kuo-Hsiung Chiu, 13F., No.23, Jiun-Ho Street, Peitun District, Taichung, 406, TW

(21) Appl. No.: 09/757,097

(22) Filed: Jan. 10, 2001

(51) Int. Cl. A61H 7/00

(52) U.S. Cl. 601/134

(57) ABSTRACT

The present invention relates to a base, a neck-holding seat and two resilient elements. The base is U-shaped, and each of two side walls thereof has an arched slide at the inner side thereof. An elongated slot is disposed at either side of the front end of a bottom surface. The neck-holding seat includes a neck-holding portion corresponding to the figure of the human neck, a guide roll disposed at each of outer sides thereof and at the corresponding position to the arched slide of the base, a positioning hook at either side of the front end of a bottom portion and at the corresponding position to the elongated slots of the base. The resilient elements is interposed between the base and the neck-holding seat and is positioned by a projecting member at either inner side of the side walls of the base and a guide roll shaft inside the neck-holding seat. Accordingly, the neck-holding seat is constantly supported at a prearranged height before the neck-holding seat presses down.

### BACKGROUND OF THE INVENTION

1. Field of the Invention

The present invention relates to a protector for cervical vertebra, and more particularly, to protection device which can be placed behind the neck when lying supine for relieving the discomfort of the cervical nerve due to improper or excessive pressure for a long time. Accordingly, it has the treatment and health-care effect.

2. Description of the Prior Art

Commonly, the head of an adult weighs about six kilogram. Therefore, the human neck supports this pressure permanently. When the cervical nerve is over-pressured (due to loading on the head or insufficient sleep) or pressured improperly (due to injury or bad sleeping position), it's easy to cause aches in the neck, fatigue and bad circulation of blood. To the serious extent, the normal daily routine is even affected.

### SUMMARY OF THE INVENTION

It is a primary object of the present invention to overcome the aforementioned problem and to provide a protector for cervical vertebra against which the neck of the normal user can lean during work, driving or rest so that the cervical nerves can be exactly relaxed in shortest time. Moreover, it can relieve the pain of the cervical vertebra patients for reaching the treatment and health-care effect.

### BRIEF DESCRIPTION OF THE DRAWINGS

The accomplishment of this and other objects of the invention will become apparent from the following description and its accompanying drawings of which:

FIG. 1 is a perspective exploded view of a preferred embodiment of the present invention;

FIG. 2 is a sectional view of FIG. 1 after assembly; and

FIG. 3 is a sectional view of FIG. 1 after assembly, showing the operation thereof.

### DETAILED DESCRIPTION OF THE PREFERRED EMBODIMENT

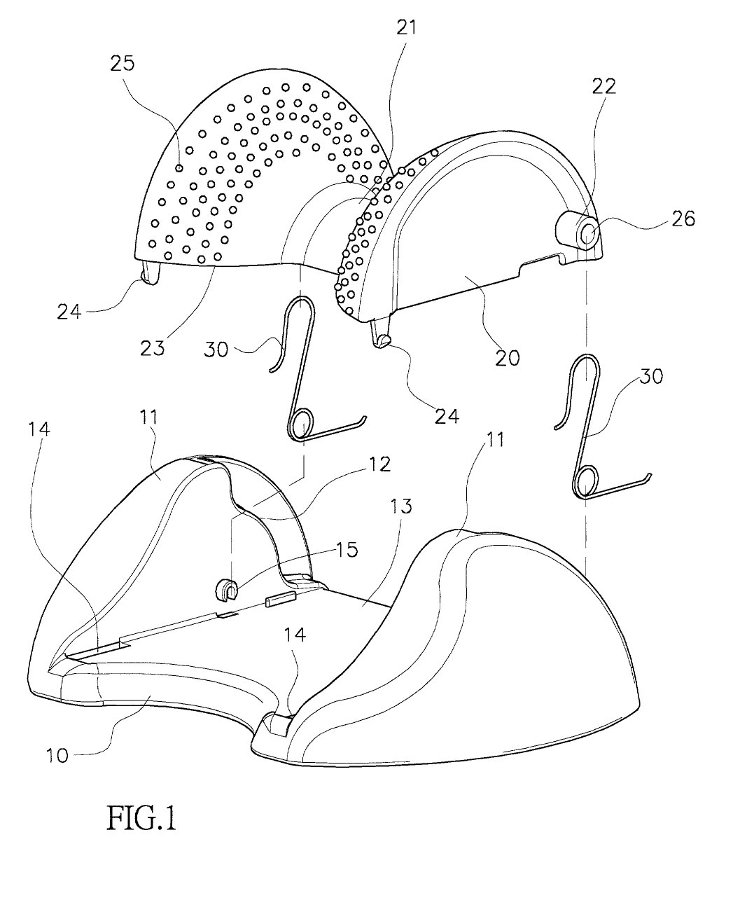

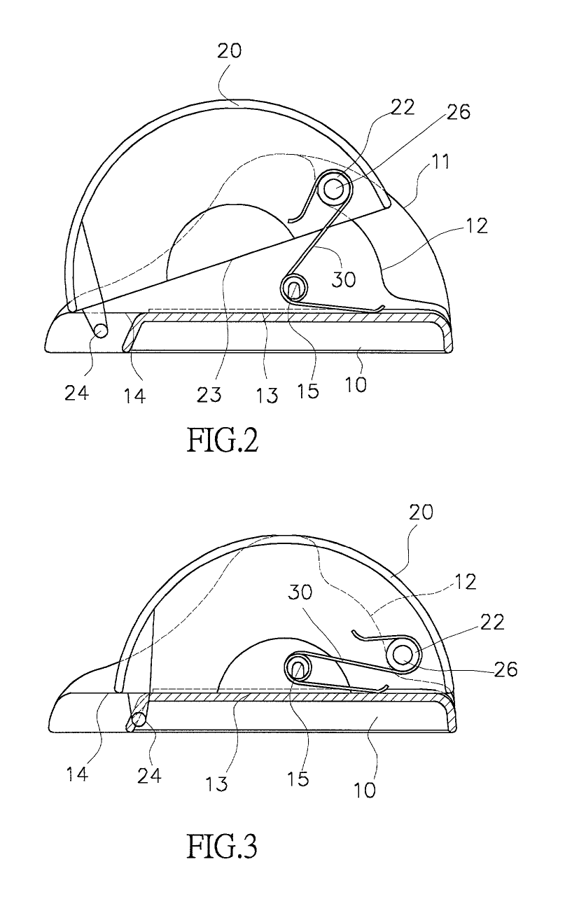

First of all, referring to FIGS. 1 and 2, the protector for cervical vertebra in accordance with the present invention includes a base 10, a neck-holding seat 20 and two resilient elements 30. The base 10 is U-shaped, and each of two side walls 11 thereof has an arched slide 12 at the inner side thereof. An elongated slot 14 is disposed at either side of the front end of a bottom surface 13. The neck-holding seat 20 includes a neck-holding portion 21 corresponding to the figure of the human neck, a guide roll 22 disposed at each of outer sides thereof and at the corresponding position to the arched slide 12 of the base 10, a positioning hook 24 at either side of the front end of a bottom portion 23 and at the corresponding position to the elongated slots 14 of the base 10. The resilient elements 30 is interposed between the base 10 and the neck-holding seat 20 and is positioned by a projecting member 15 at either inner side of the side walls 11 of the base 1 and a guide roll shaft 26 inside the neck-holding seat 20. Accordingly, the neck-holding seat 20 is constantly supported at a prearranged height before the neck-holding seat 20 presses down.

Referring to FIG. 3 again, after the aforementioned components are assembled, the human neck can be placed on the neck-holding portion 21 of the neck-holding seat 20, thereby pressing down in the direction of the base 10. Meanwhile, the neck-holding seat 20 slides down along the arched slides 12 of the base 10 by means of the guide rolls 22. In other words, the displacement of the neck-holding seat 20 allows the human head to limber up for a proper distance. Therefore, the cervical nerve obtains a full relaxation.

Before the neck-holding seat 20 presses down or after the pressing force is eliminated, it will return to the original position by the resilient elements 30.

Consequently, the present invention can be applied to any chair or seat backs for limber up one's cervical nerve.

Besides, a plurality of accupressure nodules 25 (not shown) or magnetic wave nodules (not shown) or ridges (not shown) are mounted on the surface of the neck-holding seat 20 for soothing the tired neck.

Furthermore, the resilient elements 30 can be electrically, pneumatically or hydraulically operated. Alternatively, the neck-holding seat 20 can be equipped with a vibration motor or a heater therein.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. An protector for cervical vertebra comprising:
a U-shaped base having two side walls with an arched slide at the inner side thereof, respectively, an elongated slot being disposed at either side of the front end of a bottom surface thereof;
a neck-holding seat having a neck-holding portion corresponding to the figure of the human neck, a guide roll disposed at each of outer sides thereof and at the corresponding position to said arched slide of said base, a positioning hook at either side of the front end of a bottom portion thereof and at the corresponding position to said elongated slots of said base; and
a resilient elements interposed between said base and said neck-holding seat and positioned by a projecting member at either inner side of said side walls of said base and a guide roll shaft inside said neck-holding seat;
wherein said neck-holding seat is constantly supported at a prearranged height before said neck-holding seat presses down.

2. The protector for cervical vertebra as claimed in claim 1, wherein a plurality of accupressure nodules 25 (not shown) or magnetic wave nodules (not shown) or ridges (not shown) are mounted on the surface of the neck-holding seat 20 for soothing the tired neck.
